(19) United States
(12) Patent Application Publication
(10) Pub. No.: US 2023/0201828 A1
(43) Pub. Date: Jun. 29, 2023

(54) CARTRIDGE FOR AN ANALYSIS METHOD WHICH IS ROTATION-BASED AND UTILIZES ONE-SIDED HEAT INPUT, AND ROTATION-BASED ANALYSIS METHOD

(71) Applicant: SpinDiag GmbH, Freiburg (DE)

(72) Inventors: Gregor Gross-Czilwik, Freiburg (DE); Jacob Hess, Freiburg (DE); Pierre Dominique Kosse, Freiburg (DE); Nils Paust, Freiburg (DE); Frank Schwemmer, Freiburg (DE)

(21) Appl. No.: 18/168,705

(22) Filed: Feb. 14, 2023

Related U.S. Application Data
(63) Continuation of application No. PCT/EP2021/070289, filed on Jul. 20, 2021.

(30) Foreign Application Priority Data
Aug. 14, 2020 (DE) 10 2020 210 405.0

(51) Int. Cl. B01L 3/00; B01L 7/00

(52) U.S. Cl. CPC B01L 3/502715; B01L 7/52; B01L 3/502707; B01L 2200/025; B01L 2200/028; B01L 2400/0403; B01L 2300/18; B01L 2300/0803; B01L 2300/0861; B01L 2200/0689; B01L 2300/12; B01L 2300/0848; B01L 2300/042; B01L 2200/027

(57) ABSTRACT

The invention relates to a cartridge for an analysis method which is rotation-based and utilizes one-sided heat input. The cartridge has a planar main body in which a microfluidic channel-and-chamber structure is formed, with channels interconnecting multiple process chambers, a number of positioning and/or fastening elements, formed in the main body, for positioning and/or fastening the main body on/to a support plate of an analyzer for carrying out the analysis method, and a cover body which is fastened to the main body and which is one-sidedly arranged on a top side of the main body that faces away from a heat input side and which covers at least a chamber.

### CROSS-REFERENCE TO RELATED APPLICATION

This application is a continuation, under 35 U.S.C. § 120, of copending International Patent Application PCT/EP2021/070289, filed Jul. 20, 2021, which designated the United States; this application also claims the priority, under 35 U.S.C. § 119, of German Patent Application DE 10 2020 210 405.0, filed Aug. 14, 2020; the prior applications are herewith incorporated by reference in their entirety.

### FIELD AND BACKGROUND OF THE INVENTION

The invention relates to a cartridge for an analysis method which is rotation-based and utilizes one-sided heat input. The invention further relates to a rotation-based analysis method. The invention further relates to the use of the cartridge according to the invention.

Rotation-based analysis methods are used in the medical setting with use of so-called cartridges having a channel-and-chamber structure, especially a microfluidic channel-and-chamber structure. They are usually used—besides scientific genetic material analyses and the like—for analyzing genetic material, usually in the form of DNA (deoxyribonucleic acid) or RNA (ribonucleic acid), to test for diseases present or for detecting this material to detect pathogens in any case. Starting from a sample—for example a swab, a blood sample or the like—this requires multiplication of specific regions of genetic material (DNA or RNA) contained therein. When detecting or analyzing RNA in a sample (e.g., for detection of a virus), it is first transcribed into DNA by so-called “reverse transcription” and then multiplied.

To multiply the DNA, use is usually made of the so-called polymerase chain reaction (PCR for short) in a liquid reaction. The DNA is typically present in the form of a double-helix structure consisting of two complementary single strands of DNA. In the PCR, the DNA is first separated into two single strands by an increased temperature of the liquid reaction between typically 90-96° C. (degrees Celsius) (“denaturation phase”).

Thereafter, the temperature is once more lowered (“annealing phase”, typically within a range of 50-70° C.) in order to allow specific annealing of so-called primer molecules on the single strands. The primer molecules are short complementary DNA strands which attach to a defined site on the single strands of DNA. The primer molecules (also “primers” for short) serve as the starting point for an enzyme, the so-called polymerase, which, in the so-called elongation phase, fills in the building blocks (“dNTPs”) complementary to the available DNA sequence of the single strand. Starting from the primer molecule, this gives rise to a double-stranded DNA again. Elongation is typically carried out at the same temperature as in the annealing phase or at a slightly elevated temperature, typically between 65° C. and 75° C. Following elongation, the temperature is increased again for the denaturation phase.

This cycling of the temperature in the liquid reaction between the two to three temperature ranges is called “PCR thermocycling” and is typically repeated in 30 to 50 cycles. In every cycle, the specific region of DNA is multiplied. Typically, the thermocycling of the liquid reaction in a reaction vessel is realized by controlling the external temperature. The reaction vessel is, for example, present in a thermal block in which the PCR thermocycling is realized by heating and cooling of a solid body that is in thermal contact with the reaction vessel, with heat being supplied to the liquid and dissipated from the liquid. Alternative heating and cooling concepts for realizing PCR thermocycling are, inter alia, controlling the temperature of fluids (especially air and water) that flow around the reaction vessel, and radiation-based concepts, for example by introducing heat by IR radiation or laser radiation. In the case of rotation-based methods, a chamber in the aforementioned cartridge is, for example, used as a reaction vessel and appropriately heated. In addition, the cartridge, which is usually approximately disk-shaped, is rotated.

### SUMMARY OF THE INVENTION

It is accordingly an object of the invention to provide a cartridge for an analysis method which is rotation-based and utilizes one-sided heat input, a rotation-based analysis method, and the use of a cartridge which overcome a variety of the disadvantages of the heretofore-known devices and which further improve a rotation-based analysis method.

With the above and other objects in view there is provided, in accordance with the invention, a cartridge for an analysis method which is rotation-based and which utilizes one-sided heat input, the cartridge comprising:

a planar main body having a microfluidic channel-and-chamber structure formed therein, with channels interconnecting multiple process chambers;

said main body being a substrate with said channel-and-chamber structure introduced therein and a sealing layer sealing off said channel-and-chamber structure;

a number of positioning and/or fastening elements, formed in said main body, for at least one of positioning or fastening the main body to a support plate of an analyzer for carrying out the analysis method; and

a cover body fastened to said main body, said cover body being one-sidedly arranged on a top side of said main body that faces away from a heat input side and covering at least one process chamber.

The cartridge according to the invention is configured and intended for use in an analysis method which is rotation-based and utilizes one-sided heat input. To this end, the cartridge has a planar, i.e., especially substantially two-dimensional, main body in which a microfluidic channel-and-chamber structure is formed, with channels interconnecting multiple process chambers. In particular, during the analysis method, a liquid to be analyzed is transferred between two or more of said process chambers by at least one channel in each case. Furthermore, the cartridge has a number of positioning and/or fastening elements, formed in the main body, for positioning and/or fastening the main body on/to a support plate of an analyzer which is configured and intended for carrying out the analysis method. In addition, the cartridge comprises a cover body which is fastened to the main body and which is one-sidedly arranged on a top side of the main body that faces away from a heat input side and which covers at least a (process) chamber of the channel-and-chamber structure.

Here and hereinafter, “substantially two-dimensional” is especially understood to mean that the dimensions in the plane direction of the two dimensions exceed any (thickness) variations transverse to said plane many times over, preferably more than 5 times. Here and hereinafter, the term “microfluidic” or “microfluidic channel-and-chamber structure” is especially understood to mean that the dimensions of the structure elements, preferably at least the channels, are at least mostly in the range from 30 to 700 μm (micrometers) at least in one direction, especially in the depth direction or width direction. In the case of the channels, the dimensions are preferably in this order of magnitude in two directions, namely in the depth direction and width direction. Chambers can in some cases also have larger dimensions.

In the analysis method which is rotation-based and utilizes especially one-sided heat input, the cover body prevents a comparatively high heat output on the (top) side that faces away from the heat input side, especially owing to convection. This can in turn keep the temperature distribution inside the chamber comparatively homogeneous, which in turn is advantageous for the reaction taking place inside the chamber. Furthermore, rotation allows comparatively rapid heating of the liquid contained in the chamber, since—especially with one-sided heat input—the heated interface on the heat input side of the chamber is constantly “flushed” by moving liquid and the heated partial volume is thus mixed into the rest of the liquid. This also promotes comparatively rapid denaturation of strands of genetic material. Aside from the homogeneous temperature distribution, the above-described mixing also allows otherwise homogeneous reaction conditions. This is because specific chambers in which reactions are to take place regularly prestore reaction partners, in particular specific additives, so-called “PCR primers” in the case of a polymerase chain reaction, abbreviated as “PCR”, the dissolution and mixing of which is thus promoted. The products or intermediates formed locally during the reaction can thus also be advantageously homogeneously mixed with the remaining reaction partners. In addition, a particularly homogeneous temperature distribution (especially in the case of a PCR) also allows a comparatively specific (i.e., in particular accurate or “correct”) primer hybridization (also referred to as “primer annealing”), advantageously throughout the chamber. It is clear that the annealing of primers to the “correct” DNA (target) sequences is temperature-dependent, the more specific the annealing to the target sequence, the closer the present temperature value reaches the melting temperature of binding of DNA. Thus, if there is great fluctuation in the temperature values inside the chamber, nonspecific primer hybridization regularly occurs in “cooler” regions of the chamber, whereas more specific primer hybridization occurs in warmer regions.

In a preferred embodiment, the chamber covered by the cover body is an amplification chamber, especially a so-called preamplification chamber, for multiplication of genetic material. In such a preamplification chamber, genetic material contained in a sample is multiplied in order to have available in a later method step a sufficient amount of genetic material for different test methods or for a statistically reliable test for one purpose.

The cartridge is preferably designed in such a way that the channel-and-chamber structure has, as a closed system, a plurality of consecutive and channel-connected chambers in which the material of a sample is treated, prepared for testing and also tested. This has the advantage that the material to be tested, for example genetic material, does not need to be removed from the system, which could introduce contamination.

For (pre)amplification of genetic material, a temperature treatment is carried out in particular, preferably according to the PCR thermocycling described at the start. The genetic material is therefore heated and cooled in the relevant chamber to multiple different target temperature values. Owing to the rotation of the cartridge, an artificial gravity field radial to the rotation axis is generated inside the chamber. The one-sided heat input leads at the same time to a rotating flow inside the chamber—from the heated chamber side toward the top side of the main body approximately perpendicular to the radial direction, radially outward along the top side (and thus in the direction of the “artificial gravity”) owing to the cooling-related increase in density, and then toward the heat input side again. The additional acting Coriolis force also additionally leads to a force component perpendicular to this rotating flow caused by heat input, which in turn leads to advantageous mixing inside the chamber and thus homogenization of the temperature and of the above-described reactants (i.e., sample material, reaction partners, (intermediate) products, etc.). Because less heat can be output or dissipated at the top side owing to the cover body, this leads to further homogenization of the temperature inside the chamber. In addition, the temperature inside the chamber can be specified and regulated by means of the temperature of the heating element in a comparatively stable and accurate manner (and advantageously also in a comparatively rapid manner owing to the mixing). As described above, this is advantageous especially in a PCR, preferably during a so-called annealing phase (during which primer hybridization in particular occurs), since very uniform and specific binding of the primers is made possible as a result.

In a convenient embodiment, the cover body fully covers the top side of the main body at least approximately (i.e., virtually, for example with a deviation of at most 10 percent). As a result, the above-described effect can also take effect in other chambers. In an optional variant, the cover body has a cut-out or a transparent window that makes it possible to read test results from one or more “read-out chambers”. Optionally, in the former case, the cut-out is covered by a transparent sticker, the cut-out-spanning surface of which is, however, preferably free of adhesive.

In an advantageous embodiment, the cover body has a frame web which projects in the direction of the top side of the main body and edges the covered chamber. This prevents or substantially reduces the convection parallel to the surface of the main body, i.e., especially an airflow running between the surface of the main body and the cover body, at least over the chamber to be covered, preferably the aforementioned (pre)amplification chamber. This can achieve a particularly high degree of homogeneity of the temperature (or in other words, a particularly small temperature deviation) inside the chamber (in a “virtually steady” state, especially after a comparatively long hold time of the process parameters, i.e., heating temperature and rotation speed, of for example 30 seconds upward). In particular, temperature differences below 10 K (kelvin), preferably below 5, in particular about 2 kelvins can be achieved.

Preferably, the frame web lies on the main body when used as intended. Alternatively, the frame web (when used as intended) is arranged at a slight distance, especially of less than 0.5 millimeter, preferably of about or less than (i.e., smaller than or equal to) 0.1 millimeter, from the main body.

Especially to further increase the possible rates of change in temperature for the covered chamber, the surface area thereof is chosen to be comparatively large (especially in comparison with other chambers and/or channels). For example, the covered chamber has a surface area of 2×5 mm² up to 11×16 mm², at a “depth” of about 1.1 mm. It is clear that this provides a large surface area—in comparison with the customary dimensions of the microfluidic channel-and-chamber structure—for the input of heat, and so comparatively large rates of change in temperature are possible.

In a convenient development, the covered chamber projects in a raised manner on the top side of the main body. This means that, on the top side of the main body, said chamber forms a bulge, in particular a stepped plateau (i.e., one having rectangular or at least approximately rectangular lateral walls). The chamber, in particular said plateau, specifically the lateral walls of said plateau (which especially also form at least some of the lateral walls of the chamber), overlaps with the frame web.

In a convenient variant, the frame web is made of the same material and especially integral (i.e., monolithic) with the cover body. Alternatively, in the event for example of the frame web lying on the main body and the aim being to achieve particularly effective exclusion of air in the volume above the amplification chamber (i.e., inside the space enclosed by the main body and by the cover body with frame web), the frame web is made of a resilient material, for example a thermoplastic elastomer, for example in a two-component injection-molding process.

The cover body is made of a plastic, especially a thermoplastic, and preferably produced in an injection-molding process. This makes it possible to achieve particularly economical manufacture of the cartridges.

The main body of the cartridge is made of a substrate, especially a thermoplastic substrate, into which the channel-and-chamber structure has been molded, and a sealing layer, especially a sealing film, which is fixedly connected to the substrate after a sealing step and thus closes the channel-and-chamber structure.

The rotation-based analysis method according to the invention utilizes the above-described cartridge. It is first fastened to a support plate, especially a kind of rotary plate, of an analyzer. Thereafter, the support plate is made to rotate, carrying along the cartridge. In other words, the cartridge is rotated, preferably in a plane parallel to the top side thereof. Depending on a particular method step, heat is introduced into the main body of the cartridge on one side (and preferably with local restriction to an individual chamber or only some of the chambers) by means of a number (preferably a plurality) of heating elements arranged on the support plate. Furthermore, depending on the particular method step, the speed of rotation is varied between a low speed range of up to 20 Hz, a medium speed range of between 20 and 40 Hz and a high speed range of upward of 40 Hz.

The heat input and/or the different speeds make it possible to control how, in the particular method step, liquid containing sample material and/or analysis substances is transported through the channel-and-chamber system and/or influenced in the particular chamber. “Influencing” of the sample material is understood here and below to mean, in particular, varying “treatment”, for example mechanical processing or triggering of a biochemical reaction, mixing or else measurement of an amount of liquid for subsequent steps.

“Analysis substance” is understood here and below to mean, in particular, a substance (especially molecules) which assists a reaction of preferably DNA or RNA, for example specific enzymes, amino acids, proteins and the like, or which assists the analysis downstream of the reaction, for example molecules which lead to a specific luminescence or fluorescence of certain reaction products. Especially in the case of a plurality of available chambers, such analysis substances are conveniently prestored in some of these chambers. For example, the aforementioned additives are such analysis substances.

Since the above-described cartridge is used in the method, the method also equally has all the advantages of the cartridge.

In a preferred method variant, a PCR is carried out in the chamber covered by the cover body, i.e., especially in the amplification chamber. To this end, cyclic heat input is used to set liquid temperatures inside the chamber between 50 to 75 degrees Celsius on the one hand and 80 to 100 degrees Celsius on the other. This mean that one of the temperature ranges is set first in a first cycle step and whatever is the other temperature range is set in the other cycle step. Preferably, a medium to high speed (i.e., at least 20 Hz, preferably greater than 40 Hz) is used.

In the use according to the invention, the cartridge described in greater detail here and below is used in the rotation-based analysis method.

Other features which are considered as characteristic for the invention are set forth in the appended claims.

Although the invention is illustrated and described herein as embodied in a cartridge for an analysis method which is rotation-based and utilizes one-sided heat input, a rotation-based analysis method, and the use of a cartridge, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic exploded view of a cartridge for use in a rotation-based analysis method;

FIG. 2 shows a schematic top view of a heat input side of a main body of the cartridge;

FIGS. 3, 4 show respectively a schematic top view and side view of a support plate of an analyzer, by means of which the cartridge is used as intended;

FIG. 5 shows a view as per FIG. 3 of the support plate with a partially assembled cartridge;

FIG. 6 shows a view as per FIG. 3 of the support plate with the cartridge in the intended use state;

FIG. 7 shows a schematic view of a bottom side of a cover body of the cartridge;

FIGS. 8-11 each show a view as per FIG. 2 of the main body of the cartridge to illustrate substeps of the analysis method;

FIG. 12 shows a schematic detailed view of a chamber of the cartridge presented as a detail drawing;

FIGS. 13-15 show a partial sectional view of the chamber of the cartridge that is in the form of a detail drawing and schematic; and

FIGS. 16-19 each show a view as per FIG. 2 of the main body of the cartridge to illustrate further substeps of the analysis method.

Parts that correspond with one another are provided with the same reference signs throughout the figures.

### DETAILED DESCRIPTION OF THE INVENTION

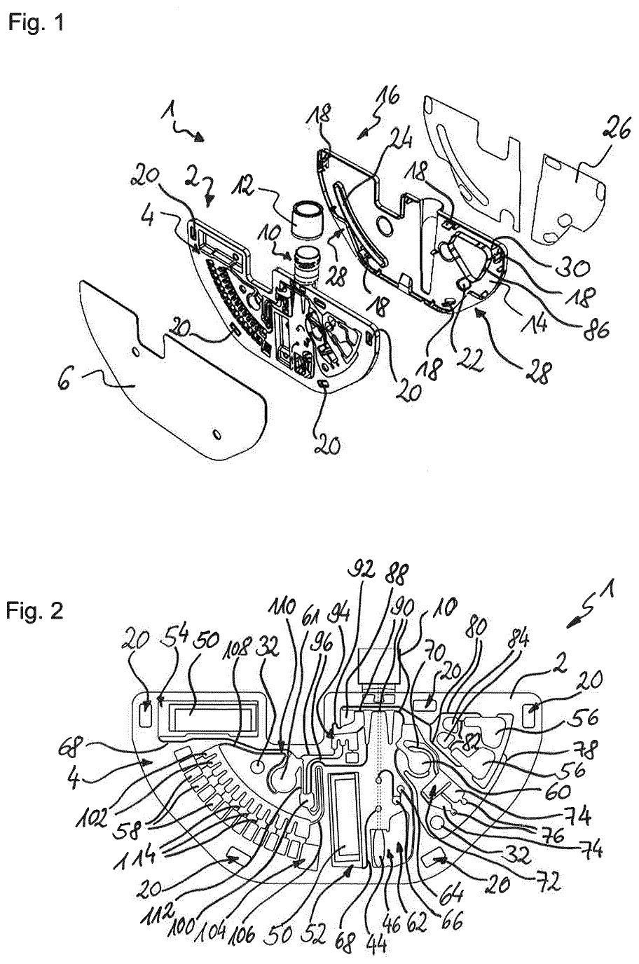

Referring now to the figures of the drawing in detail and first, in particular, to FIG. 1 thereof, there is shown schematically a sample container referred to as a “cartridge,” or else concisely as “disk 1” owing to the planar geometry approximating a halved circular disk. Said disk 1 is for use in a rotation-based analysis method, which will be described in greater detail below. The disk 1 has a main body 2 (also referred to as “substrate”) which has a microfluidic channel-and-chamber structure 4. Said channel-and-chamber structure 4 has in turn multiple chambers, which will be described in greater detail below and which are connected to one another by means of respectively assigned channels (cf. FIG. 2). In the unassembled state, the chambers and channels each form “exposed” bowl- or groove-like indentations in the main body 2. The disk 1 therefore also has a sealing film 6 (or else: “sealing layer”) which is heat-sealed onto the microfluidic main body 2 and thus closes the channel-and-chamber structure 4 from a side referred to hereinafter as “heat input side 8”. The main body 2 has a lateral inlet 10 to the channel-and-chamber structure 4, through which sample material can be introduced into the channel-and-chamber structure 4. Said inlet 10 is reversibly closable by means of a cap 12 in order to allow the introduction of the sample material and subsequent reclosure. In addition, the disk 1 has a cover body, referred to hereinafter concisely as “cover 14”, which is placed onto the main body 2 on a “top side 16” (or else “reverse side” in relation to the heat input side 8) and fixed thereto in corresponding slots 20 of the main body 2 by means of locking hooks 18 (see FIG. 7) in the present exemplary embodiment. The cover 14 has a first and a second read-out window 22 and 24, through which the contents of underlying chambers of the main body 2 can be read and thus analyzed (e.g., by means of fluorescence detection) or at least monitored.

In an optional variant (depicted here), the disk 1 also has a (here: two-part, preferably self-adhesive) label 26 which is applied to the cover 14. The label 26 is designed in such a way that it allows read-out through the read-out windows 22 and 24. In an optional development of this variant, the label 26 has transparent regions which cover the read-out windows 22 and 24. Conveniently, said transparent regions are not provided with adhesive—i.e., kept free of adhesive—so that fluorescence detection is not influenced by possibly luminescent adhesive.

Laterally molded in the cover 14 in a lateral wall 30 are recesses 28 which allow alignment and positioning of the disk 1 in an automatic feed of an analyzer.

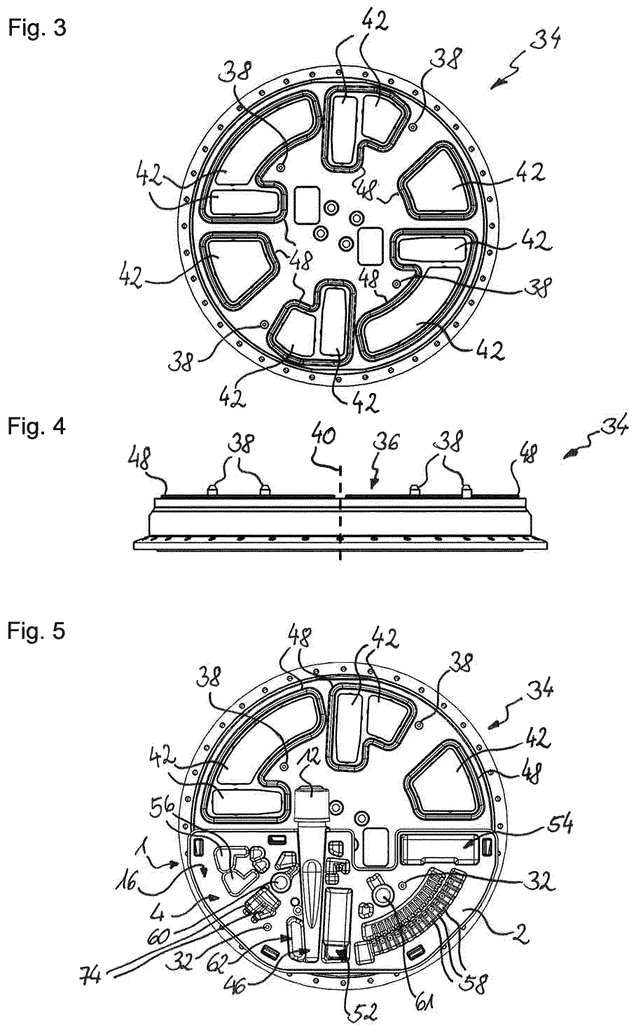

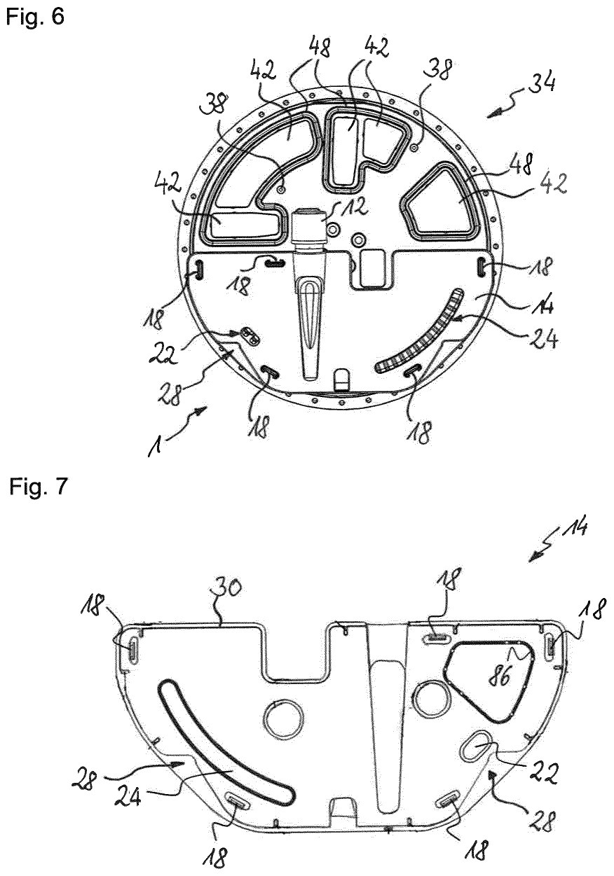

The main body 2 has multiple (here: specifically two) through-holes 32 which are used for clear alignment and positioning of the disk 1 on a support plate (referred to hereinafter as “rotary plate 34”, see FIGS. 3 to 5) of the analyzer. Positioning pins 38 of the rotary plate 34 engage said through-holes 32 for positioning and fixation in a rotation plane 36 parallel to the surface of the rotary plate 34 and to the heat input side 8 (and thus to the planar extent) of the disk 1.

The rotary plate 34 of the analyzer is used for centrifugation, i.e., for rotation of the disk 1 about a rotation axis 40 (see FIG. 4). The rotary plate 34 is configured to be able to optionally accommodate two disks 1 and therefore has 180-degree rotational symmetry (see FIG. 3). In addition, the rotary plate 34 bears multiple heating elements 42 which are used for local heating of individual chambers of the channel-and-chamber structure 4 of the disk 1 and are therefore matched in terms of their outer contour to the corresponding chambers. In the present case, the heating elements 42 are formed by resistance heating plates.

In an alternative exemplary embodiment, the heating elements 42 are formed by Peltier elements, which also allow active cooling.

Individual chambers, channels and further elements of the disk 1 will be described in greater detail below on the basis of the method sequence described below.

To carry out the analysis method, at least one disk 1, into which a swab 44 has been inserted through the inlet 10 as sample material carrier into a swab chamber 46 of the channel-and-chamber structure 4, said inlet 10 then being closed by means of the cap 12, is inserted into the analyzer and positioned and placed on the rotary plate 34. If only one disk 1 is inserted, the analyzer is configured to automatically counterbalance the rotary plate 34 (in particular by arranging counterweights on the rotary plate 34). For fixation, the disk 1 is sucked onto the rotary plate 34 by means of a vacuum pump. Sealing contours 48 encircling the heating elements 42 are used for this purpose. The disk 1 is in contact therewith and can therefore be regionally sucked onto the rotary plate 34. This conveniently allows close contact between the heating elements 42 and the regions of the disk 1 to be locally heated.

In an initial state (i.e., without already introduced sample or without swap 44), the disk 1 contains prestored additives or analysis substances in the form of liquid reagents in closed stickpacks 50 in a first stickpack chamber 52 and a second stickpack chamber 54. Furthermore, so-called primers are also prestored in preamplification chambers 56 as additives or analysis substances. Further primers and so-called probes (also referred to as “gene probes”, usually in the form of polynucleotides or oligonucleotides) are prestored in multiple read-out chambers 58. Said read-out chambers 58 are visible through the read-out window 24 of the cover 14. The primer pairs in the preamplification chambers 56 are—depending on the specific goal of the analysis method and/or of the specific procedure—identical or different. For example, the primers in the read-out chambers 58 are pairwise identical to the primers in the preamplification chambers 56 or, for example, provided for a “nested PCR”, as known in the prior art, and therefore different.

Prestored in a first, approximately round “lyochamber 60” and a second, likewise approximately round lyochamber 61 are lyophilisates containing, for example, enzymes, polymerase, dNTPs (deoxynucleoside triphosphates), salts and/or other prestored reagents (e.g., PCR additives, nuclease inhibitors, cofactors of the enzymes concerned, etc.). In the present exemplary embodiment, the swab chamber 46 contains a lysis and means for process control, for example spores, fungi, phages or artificially produced targets. A lysis chamber 62 connected to the swab chamber 46 contains a lysis pellet and also a magnet and a grinding medium. The latter is, for example, glass particles and/or zirconia particles. Said particles are optionally coated with EDTA or it has been added in order to prevent coagulation in blood as sample material. To bind inhibitors, activated carbon is optionally added. This means that, in such an optional case, activated carbon is likewise prestored.

After sampling—for example by means of a blood capillary as an alternative to the swab 44 (in sterile form in the medical setting)—the sample carrier, i.e., the swab 44 in the present case, is thus inserted into the disk 1, specifically into the swab chamber 46, and the inlet 10 is closed with the cap 12. The cap 12 provides an air-tight seal in order to avoid the escape of any pathogens present in the sample material. In an optional exemplary embodiment, the disk 1, specifically the main body 2, has a vent hole 64, upstream of which are a filter and a condensation trap 66 (in the form of a comparatively small chamber). The latter allows moistening of the filter with condensation. In an alternative exemplary embodiment, the vent hole 64 can, however, also be omitted.

After the disk 1 has been positioned and fixed on the rotary plate 34, the lysis of the sample material is started by magnets arranged in the analyzer being driven over the disk 1. As a result, a magnetic field variable relative to a reference system of the disk 1 is generated and the magnet arranged in the lysis chamber 62 is moved. Owing to the movement of the magnet, the particles of the grinding medium that are present in the lysis chamber 62 are rubbed against one another, with the result that bacteria, fungi, viruses or other analytes are disrupted.

In an optional method step, this mechanical lysis is thermally assisted by heating the lysis chamber 62 by means of the relevant locally assigned heating element 42.

Meanwhile, there is rotation of the rotary plate 34 and thus also of the disk 1, with the result that comparatively large sample particles are sedimented owing to centrifugation. This not only increases tolerance of biochemical inhibition, but also reduces the risk of clogging of microfluidic channels of the channel-and-chamber structure 4.

Optionally, the sample can be already multiplied in this starting step by means of a polymerase chain reaction (PCR) or an isothermal method (e.g., loop-mediated isothermal amplification or LAMP for short, or recombinase polymerase amplification or RPA for short). Also conceivable is an nonspecific amplification in this starting step by means of so-called whole-genome amplification, based for example on PCR or MDA (multiple displacement amplification).

In general, the sample material is, however, first homogenized as a result of the movement of the magnet and the particles, optionally assisted by convection based on a temperature gradient occurring in the lysis chamber 62 owing to the optional one-sided heating. If a biochemical reaction in the lysis chamber 62 should additionally be envisaged, the reaction conditions in the lysis chamber 62 are also simultaneously kept homogeneous as a result, i.e., in particular a stable temperature distribution is established and/or a high degree of mixing of materials is achieved. This is particularly relevant to samples of very low concentration or to difficult-to-lyse samples. Shearing of DNA or RNA that is likewise possible can assist later amplification, since secondary structures are reduced as a result. Owing to the mechanical action of the moved magnet and the forces applied to the sample material as a result, what can be (randomly) cut (“sheared”) are namely DNA or RNA strands. The strength of the shearing can be controlled by the duration and intensity of the mechanical action (i.e., thus the “mechanical lysis”), for example the speed of movement of the magnet. However, care has to be taken that DNA and RNA are not excessively sheared, since amplification is otherwise no longer possible.

In addition, in a further method step, the stickpack chambers 52 and 54 are heated locally to about 90° C. by means of the relevant heating elements 42 and, afterwards (optionally also at the same time), the speed of the rotary plate is increased to over 30 Hz, in particular in the region of about 60 Hz. With this centrifugation at medium to high speed, the stickpacks 50 are opened within a comparatively short time of about 5 seconds owing to the combination of heating and centrifugal force. Owing to heating, what is thermally weakened is namely a tear seam or peel seam of the stickpacks 50 formed from a so-called peel film.

During rotation at at least 25 Hz, especially at the more than 30 Hz, preferably about 60 Hz, described above, overpressure builds up owing to the heating of the stickpack chambers 52 and 54. The overpressure is driven by the expansion of the gas present in the respective stickpack chamber 52 and 54 (owing to the ideal gas law) and a vapor pressure dependent on the stickpack liquid and the temperature in the stickpack chamber 52 and 54. With subsequent reduction of the speed, said overpressure leads to displacement of most of the liquid (preferably more than 90%) from the stickpack chamber 52 and 54 through the respectively connected channels 68 to the lysis chamber 62 and to the lyochamber 61, respectively. Said displacement occurs robustly against the centrifugal forces within the disk 1 even at a centrifugation at 10 to 30 Hz. The liquid displaced from the stickpack chamber 54 dissolves a lyophilisate which is present in the lyochamber 61 and which contains portions of the reagents for later main amplification. This liquid transfer into the lysis chamber 62 or lyochamber 61 takes place before or during the above-described (mechanical) lysis in the lysis chamber 62 in order to be able to already utilize here the liquid of the stickpack 50 of the stickpack chamber 52.

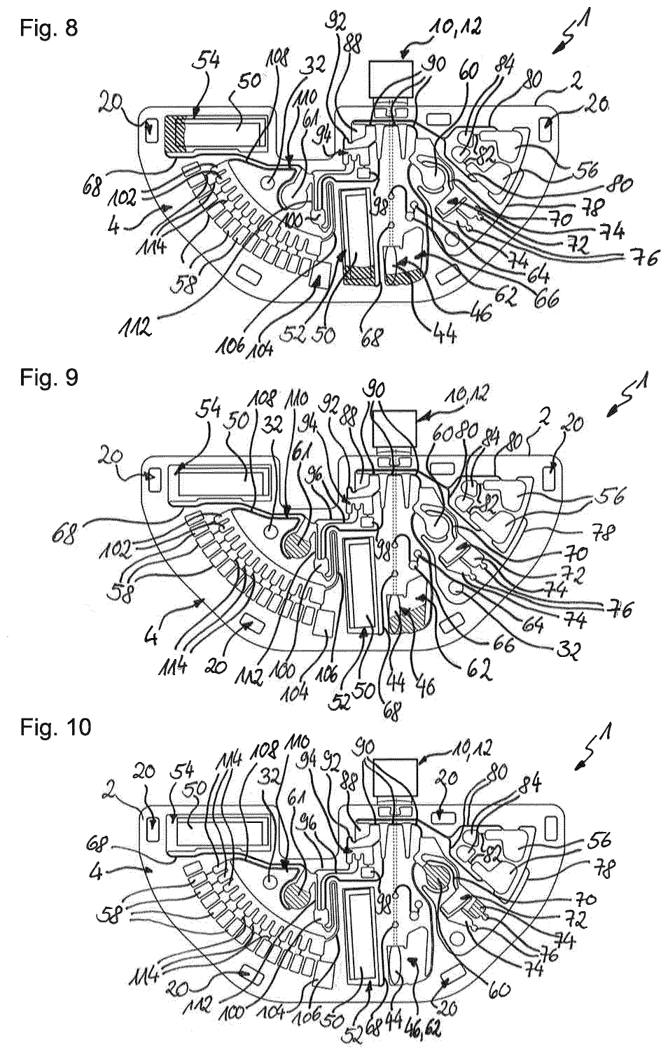

FIG. 8 depicts the opened stickpacks 50 and, shaded in the stickpack chamber 54, the liquid which has escaped from the stickpack 50. From the stickpack chamber 52, some of the liquid has already passed over into the swab chamber 46 and the lysis chamber 62. FIG. 9 depicts the state of the stickpack chambers 52 and 54 after displacement of the respective liquid.

In a subsequent method step, the liquid (the “lysate”) is transported from the lysis chamber 62 into the subsequent lyochamber 60 (depicted in FIGS. 8 to 11 on the right above the lysis chamber 62), in which the lysate dissolves the lyophilisate prestored therein (see FIG. 10). Besides the afore-mentioned amplification reagents, said lyophilisate can optionally also contain nuclease inhibitors, for inactivation of specific nucleases, and further additives or cofactors such as dithiothreitol (DTT). The transport of the lysate is —again against the centrifugal force of the continuing rotation of the disk 1—driven by heating of the upstream stickpack chamber 52 and/or of the lysis chamber 62 and/or cooling of the preamplification chambers 56 subsequently fluidically connected to the lyochamber 60, of the (opposite) stickpack chamber 54 and/or of the read-out chambers 58. The cooling of the subsequent chambers causes a suction effect owing to an underpressure, and the heating of the upstream chamber or chambers accordingly conversely causes forward movement of the liquid owing to the overpressure.

The lyochamber 60 is connected to an overflow chamber 72 by means of an overflow channel 70. During transport of the lysate from the lysis chamber 62 into the chamber 60, excess lysate flows through the overflow channel 70 into the overflow chamber 72. Connected to the overflow chamber 72 are control chambers 74 and 76, which are used to check for correct filling of the disk 1. Lysate flowing off into the overflow chamber 72 fills, from there, the control chambers 74 and the control chambers 76 (depicted schematically in FIG. 10). The filling of the control chambers 74 and 76 is used to check for correct filling of the disk 1. In particular, the filling of the control chamber 74 of roughly square geometry depicted in FIG. 10 on the right, specifically the filling of the control chamber 76 radially outwardly joined thereto, is understood to mean that there is no underfilling of the disk 1. The filling of the roughly triangular (cf. FIG. 10) control chamber 74 fluidically following, on the left, the roughly square control chamber 74, specifically the filling of the control chamber 76 radially outwardly joined thereto, is by contrast understood to mean that there is overfilling of the disk 1. The total liquid volume present here is composed of the volume of the sample material introduced, usually about 105 to 170 microliters, and of the stickpack 50 of the stickpack chamber 52, about 140 to 160 microliters. The filling of the relevant control chambers 74 and 76 can be monitored by a fluorescence detector through the read-out window 22 of the cover 14 at a specific moment (e.g., at the end of the entire analysis method) or else continuously during the filling of the lyochamber 60. As a result, it is possible to determine the moment at which the control chambers 74 and 76, and thus also lyochamber 60, have been filled. This in turn makes it possible to infer possible sources of error. In an optional exemplary embodiment, a dried fluorescent dye is stored in the control chambers 74 and/or 76 in order to obtain a relatively strong signal.

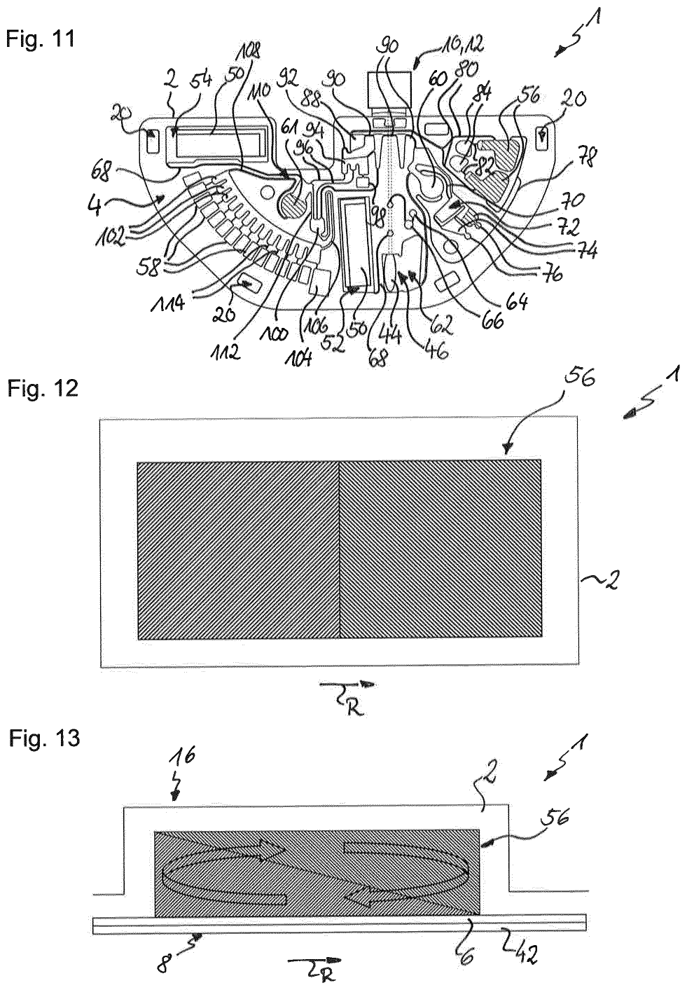

In a further method step, liquid is subsequently transferred from the lyochamber 60 into the preamplification chambers 56 through a transfer channel 78 by means of a high speed of 40-60 Hz. Once the liquid level in the preamplification chambers 56 goes beyond a mouth of a respective outlet channel 80, there is compression of the trapped air volume in the (radially inwardly pointing) “head space” of the preamplification chambers 56 and in one downstream chamber 84 each, connected via an assigned channel 82 (see FIG. 11).

Under high centrifugation at speeds of 40-80 Hz, what takes place in the subsequent method step is preamplification in the preamplification chambers 56. The overpressure in the preamplification chambers 56 and the chambers 84 is maintained during the preamplification owing to the high centrifugation. Primers prestored in the preamplification chambers 56, for example spotted with trehalose, are first dissolved. If RNA is to be detected, reverse transcription can optionally first be carried out at a constant 35-70° C. for 30 seconds to 10 minutes or to 30 minutes in order to transcribe any RNA present into DNA. However, the preamplification by means of PCR occurs by local and cyclic heating and cooling of the liquid in the preamplification chambers 56 between the ranges 50-75° C. and 80-100° C. The preamplification comprises 5-30 preamplification cycles. Each cycle comprises heating to 80-100° C. and subsequent cooling to 50-75° C.

The (preamplification) reaction inside the preamplification chambers 56 is assisted by a high degree of convection. It is caused by the one-sided heat input into the disk 1, specifically into the preamplification chambers 56 from the heat input side 8, and the simultaneously occurring rotation. As can be seen from FIGS. 12 and 13, the liquid in the preamplification chamber 56 is first heated at the heat input side 8 heated by means of a heating element 42 and it thus forms a heated interface. At the same time, the density of the interface decreases relative to the rest of the liquid volume. The heated liquid of the interface rises in the artificial gravity field which is caused by the rotation of the disk 1 and which is oriented in the radial direction R, first “inwardly” against the radial direction R and then transversely to the radial direction R toward the top side 16. There, the liquid cools and falls “owing to gravity” along the top side 16, outwardly in the radial direction R, and then back toward the heat input side 8 (see FIG. 13). What thus occurs as a result of the heat input is convection and flow along the radial direction R. The temperature and density distribution is roughly schematically indicated by the differently shaded regions in FIG. 12 (in top view from the top side 16) and FIG. 13. Furthermore, the Coriolis forces that likewise occur lead to the formation of a tangential (i.e., perpendicular to the radial direction R in the plane direction of the disk 1) flow component, which additionally supports the mixing of the liquid. Since the convection is caused by the artificial gravity field, it is increased by faster rotation of the disk 1. The convection that occurs at high speeds thus leads to particularly effective mixing of the reaction components inside the preamplification chambers 56, and this in turn allows efficient amplification conditions.

However, one side effect is that, in the case of very high heat output on the nonheated top side 16 of the disk 1, a high temperature gradient of, for example, 10° C. (or kelvins) can form within the liquid volume of the preamplification chamber 56, which may be disadvantageous. In the exemplary embodiment depicted in FIG. 13 (in which the cover 14 is not present), heating by means of a heating element 42 adjusted to 97° C. leads to a temperature value of 95° C. in the bottom-left region of the preamplification chamber 56 (diagonally shaded toward the top right) and a temperature value of 85° C. in the top-right region of the preamplification chamber 56.

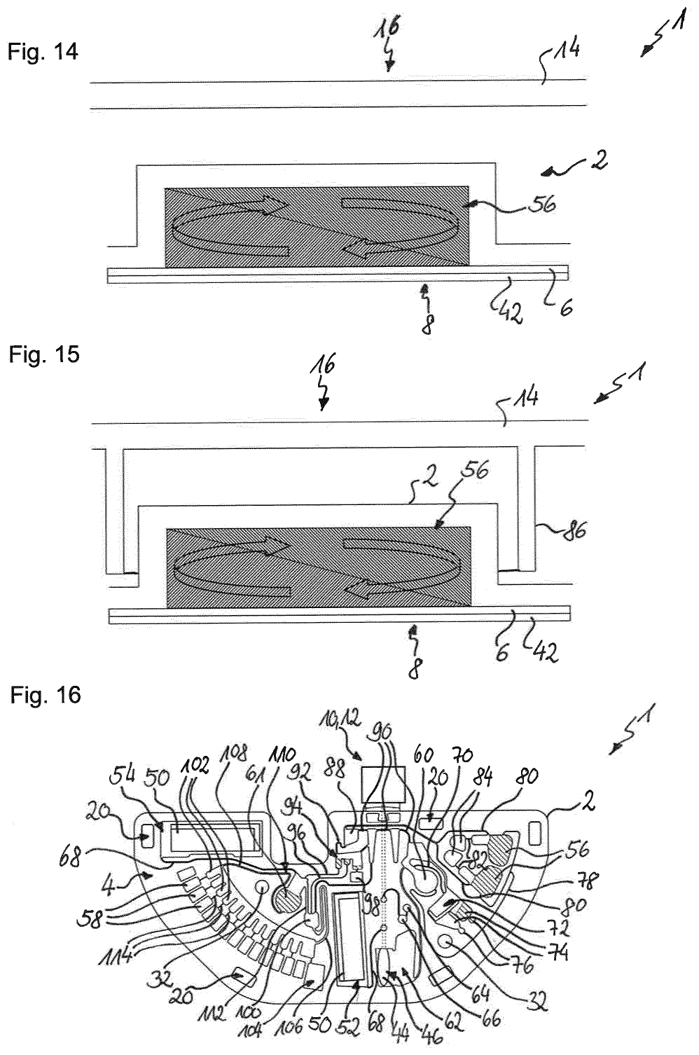

In the exemplary embodiment depicted in FIG. 14, such a high temperature gradient is reduced by the cover 14, which brings about air shielding. At identical heat input, it is thus possible to achieve a temperature value in the bottom-left region and top-right region of 95° C. and 91° C., respectively, and therefore a difference of 4 kelvins.

For further reduction of the heat output, the cover 14 has, in a further exemplary embodiment, a frame web 86 which annularly surrounds the preamplification chambers 56 and therefore further reduces the heat output due to convection on the top side 16 (see FIGS. 1, 7 and 15). The frame web 86 is overmolded onto the cover 14, i.e., integrally connected thereto. The frame web 86 projects in the direction of the main body 2 and ends at a small distance of about 100 μm from the main body. At the same time, the frame web 86 surrounds the preamplification chambers 56, which are raised on the top side 16 in the form of a plateau, including on the sides thereof. This extended shielding of the preamplification chambers 56 by the cover 14 and the frame web 86 allows a temperature difference of about 2 kelvins inside the respective preamplification chamber 56, i.e., between the two regions shaded differently in FIG. 15. Comparatively strong convection therefore does occur in the respective preamplification chamber 56 owing to, inter alia, the rotation. However, what is additionally also achieved is a comparatively high degree of homogeneity of the reaction temperature inside the preamplification chamber 56—at least in the static case, i.e., when holding the temperature of the heating element 42 for at least about 10 to 30 seconds. In the case of the geometry described here and below and the parameters applied, experience has shown that static conditions already arise from about 15 seconds.

In the event too of the occurrence in the preamplification chambers 56 of a reaction which requires an interaction, for example binding of molecules to a solid phase, for example to microarrays, or a reaction in which the concentration of the respective reaction partners is usually low and mutual contact of the respective reaction partners is therefore subject to a comparatively low probability, the high degree of convection (and therefore comparatively strong mixing) and the homogeneous temperature distribution can be advantageous.

After completion of the preamplification, the speed is reduced to about 5 to 20 Hz, specifically to about 10 Hz. As a result, the compressed air volume in the head space of the preamplification chambers 56 and in the chambers 84 can expand. This leads in turn to lowering of the liquid level inside the preamplification chambers 56, by liquid which is radially within the mouth of the outlet channels 80 being at least mostly displaced by the expanding air through the outlet channels 80 into a further chamber 88. This is made possible by the outlet channels 80 having a lower fluid resistance, specifically a larger channel cross section, than the transfer channel 78 leading into the preamplification chambers 56.

The disk 1 has vent channels 90 which, inter alia, are connected to the chamber 88 and allow internal venting of the disk 1 into other chambers. Therefore, air which would be compressed by liquid flowing into the chamber 88 can escape via the vent channels 90 in the direction of the lyochamber 60.

In a subsequent method step, the speed of the disk 1 (or the rotary plate 34) is adjusted, specifically increased, to a value range of 10-20 Hz, preferably to about 15 Hz. As a result, the liquid from the chamber 88 flows via a siphon 92 into a measurement chamber 94 which has radially outwardly three “measurement fingers” or chamber projections of differing volume. Said measurement fingers are filled successively, and so the specified (measurement finger) volume leads to measurement of individual subvolumes (see FIG. 16). The flow of the liquid through the channels 96 radially outwardly connecting to the measurement fingers is limited by high fluidic resistances of said channels 96, specifically by the channel dimension thereof being smaller than 200 pm in at least one spatial direction, specifically in a cross-sectional direction. The subvolume which respectively flows through the channels 96 in the subsequent step is thus substantially specified by the volume of the respective upstream measurement finger. Excess liquid volume flows to an overflow 98.

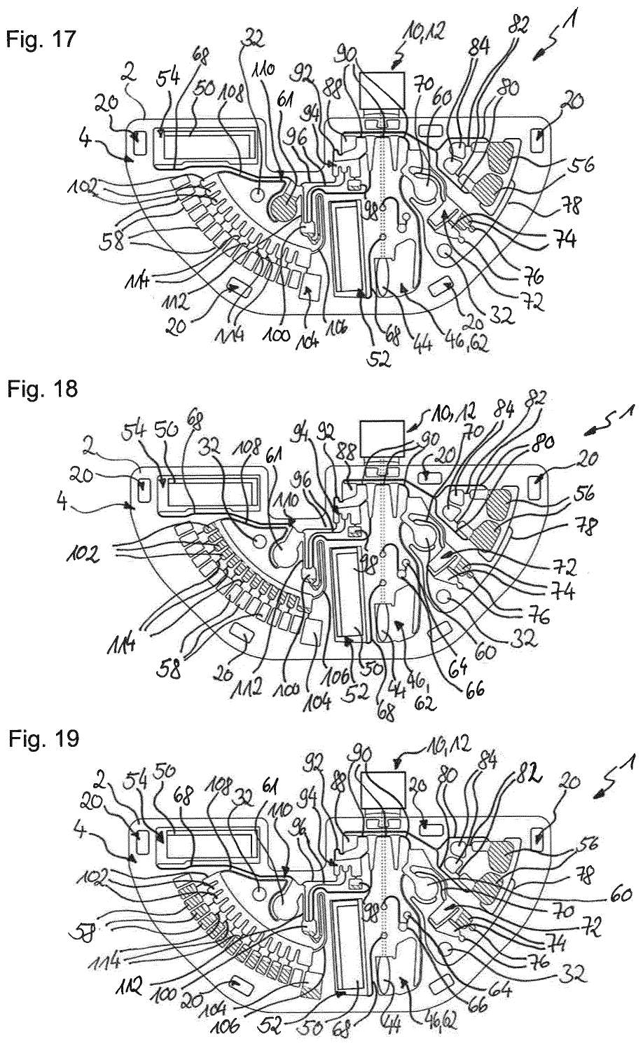

In the next method step (see FIG. 17), increasing the centrifugation, i.e., the speed, to a range between 30 and 80 Hz, specifically to about 60 Hz, drives the measured subvolumes of the liquid into the respectively subsequent chambers, i.e., into the lyochamber 61 depicted to the left of the swab chamber 46 in FIG. 17 and into a further chamber 100.

Now, present in said lyochamber 61 are a “main amplification buffer”, which was originally prestored in the stickpack 50 arranged in the stickpack chamber 54, a lyophilisate now dissolved in this liquid, which lyophilisate was prestored in the lyochamber 61, and the “preamplification product” contained in the liquid from the preamplification chambers 56, which preamplification product was supplied via the channel 96.

In a subsequent method step, the disk 1 is rotated under comparatively rapid changes of direction, each with a change rate of 5 to 40 Hz/s, preferably by 30 Hz/s, between end values of −20 to 40 and +20 to 40 Hz.

In this case, the signs indicate the different rotation directions. The components present in the lyochamber 61 are mixed owing to the accelerations occurring with the changes of direction and to Euler and Coriolis forces generated as a result in the rotation system.

In parallel, the read-out chambers 58, measurement chambers 102 upstream thereof, and an overflow chamber 104 are heated by means of the correspondingly assigned heating element 42. The air expanding as a result can escape into the chamber 100 via a compensation channel 106. The mixing operation is completed by ending the changes of direction and returning to a constant speed of about 20 Hz. Thereafter, the read-out chambers 58, the measurement chambers 102 and the overflow chamber 104 are cooled back down. As a result, a relative underpressure is formed in the relevant chambers 58, 102 and 104 and the fill level in a siphon channel 108 subsequently connected to the lyochamber 61 and in the compensation channel 104 connected to the chamber 100 rises depending on a ratio between centrifugal pressure and difference in air pressure. Once the liquid goes beyond the vertex 110 of the siphon channel 108, the entire liquid is driven out of the lyochamber 61 into the subsequent measurement chambers 102 (see FIG. 18). A vent channel 112 between the lyochamber 61 and the chamber 100 allows air exchange between these two chambers 61 and 100.

The liquid flows successively into the individual measurement chambers 102 and is measured as a result. Furthermore, the liquid in the measurement chambers 102 is initially retained by one centrifugal pneumatic value each in the form of one valve channel 114 each. Excess liquid flows off into the overflow chamber 104. The centrifugal pneumatic values are based on the fact that the liquid is retained in the respective valve channel 114 by the counter-pressure in the respectively subsequent read-out chamber 58 and cannot flow into the subsequent read-out chambers 58 at a speed in the medium speed range, specifically of about 15-25 Hz here.

In a subsequent method step, the speed is sufficiently increased, typically to over 40 Hz, for the (liquid) menisci in the respective valve channels 114 to become unstable owing to the so-called “Rayleigh-Taylor instability” and for the liquid to therefore be at least mostly transferred into the corresponding read-out chamber 58 (see FIG. 19).

In a further method step, what now take place in the read-out chambers 58 are the main amplifications. To this end, the primers and probes respectively prestored in the read-out chambers 58 are dissolved. The dissolution of the primers and probes and the subsequent amplification are assisted by a high degree of convection inside the read-out chambers 58, the cause of which is as described above with reference to FIGS. 12 and 13. The reaction is read after each cycle at about 60° C. in all read-out chambers 58 by means of a fluorescence detector. It detects the fluorescence in different wavelengths. Readings are made through the read-out window 24 in the cover 14. The operation therefore corresponds to a so-called “real-time PCR”. In this case, what can take place in each of the twelve read-out chambers 58 is a multiplex reaction, for example 3-plex to 10-plex. A relevant rise in signal in the fluorescence detector indicates a detected target.

So that the optical evaluation by means of the fluorescence detector is not influenced or is minimally influenced, the read-out chambers 58 have radially inwardly, beyond the region looked at by means of the fluorescence detector, an indentation which is not depicted in greater detail and which is used “to collect” air bubbles and hold them back from the region looked at. An air bubble arranged in said indentation would have to be comparatively greatly deformed in order to enter the region looked at. Advantageously counteracting here is the bubble interface, especially influenced by the present surface tension conditions.

Further optionally, the read-out window 24 which covers the read-out chambers 58 and which is transparently closed in this case is also edged by a frame web (cf. FIG. 1) comparable to the frame web 86, and so the heat output from the read-out chamber 58 can be reduced here as well.

As an alternative to fluorescence detection, the evaluation can also be done via a so-called melt curve analysis, for example a “high-resolution melt curve analysis” or a “rapid melt curve analysis”. This would allow even much higher multiplexing. In an optional exemplary embodiment, what is carried out in the read-out chambers 58 is a “real-time PCR” based on so-called intercalating dyes (e.g., dyes known under the brand or the name “EvaGreen”, “SYBR Green”, “BoxTo”), the resultant PCR products being detected after amplification via melt curves. Here, up to 20 PCR products can be detected and differentiated per chamber (20-plex).

The subject matter of the invention is not restricted to the above-described exemplary embodiments. Rather, further embodiments of the invention can be derived from the above description by a person skilled in the art. In particular, the individual features of the invention described on the basis of the various exemplary embodiments and their design variants can also be combined with one another in another way.

The following is a summary list of reference numerals and the corresponding structure used in the above description of the invention:

1 Disk

2 Main body

4 Channel-and-chamber structure

6 Sealing film

8 Heat input side

10 Inlet

12 Cap

14 Cover

16 Top side

18 Locking hook

20 Slot

22 Read-out window

24 Read-out window

26 Label

28 Recess

30 Lateral wall

32 Through-hole

34 Rotary plate

36 Rotation plane

38 Positioning pin

40 Rotation axis

42 Heating element

44 Swab

46 Swab chamber

48 Sealing contour

50 Stickpack

52 Stickpack chamber

54 Stickpack chamber

56 Preamplification chamber

58 Read-out chamber

60 Lyochamber

61 Lyochamber

62 Lysis chamber

64 Vent hole

66 Condensation trap

68 Channel

70 Overflow channel

72 Overflow chamber

74 Control chamber

76 Control chamber

78 Transfer channel

80 Outlet channel

82 Channel

84 Chamber

86 Frame web

88 Chamber

90 Vent channel

92 Siphon

94 Measurement chamber

96 Channel

98 Overflow

100 Chamber

102 Measurement chamber

104 Overflow chamber

106 Compensation channel

108 Siphon channel

110 Vertex

112 Vent channel

114 Valve channel

R Radial direction

1. A cartridge for an analysis method which is rotation-based and which utilizes one-sided heat input, the cartridge comprising:
a planar main body having a microfluidic channel-and-chamber structure formed therein, with channels interconnecting multiple process chambers;
said main body being a substrate with said channel-and-chamber structure introduced therein and a sealing layer sealing off said channel-and-chamber structure;
said main body being formed with a number of positioning and/or fastening elements for at least one of positioning or fastening the main body to a support plate of an analyzer for carrying out the analysis method; and
a cover body fastened to said main body, said cover body being one-sidedly arranged on a top side of said main body that faces away from a heat input side and covering at least one process chamber.

2. The cartridge according to claim 1, wherein said process chamber covered by said cover body is an amplification chamber for a multiplication of genetic material.

3. The cartridge according to claim 1, wherein said cover body is configured to cover said top side of said main body substantially completely.

4. The cartridge according to claim 1, wherein said cover body has a frame web which projects in a direction of said top side of said main body and forms a frame around said at least one chamber covered by said cover body.

5. The cartridge according to claim 4, wherein said frame web, in an operational orientation of the cartridge, lies on said main body or is arranged at a slight spacing distance from said main body.

6. The cartridge according to claim 5, wherein said spacing distance is less than 0.5 millimeter.

7. The cartridge according to claim 5, wherein said spacing distance is smaller than or equal to 0.1 millimeter.

8. The cartridge according to claim 5, wherein said at least one chamber covered by said cover body projects in a raised manner on the top side of said main body and overlaps with said frame web.

9. The cartridge according to claim 1, wherein said cover body is made of plastic.

10. The cartridge according to claim 9, wherein said cover body is made of a thermoplastic.

11. The cartridge according to claim 1, wherein said main body comprises a thermoplastic substrate.

12. A rotation-based analysis method, comprising:
fastening a cartridge according to claim 1 to a support plate of an analyzer;
causing the support plate to rotate, carrying along the cartridge;
depending on a particular method step, introducing heat into the main body on one side by way of a number of heating elements arranged on said support plate; and
depending on the particular method step, varying a speed of rotation between different speed ranges.

13. The analysis method according to claim 12, which comprises varying the speed of rotation between a low speed range of up to 20 Hz, a medium speed range of between 20 and 40 Hz, and a high speed range of from 40 Hz.

14. The analysis method according to claim 13, which comprises:
causing a polymerase chain reaction to occur in the chamber that is covered by the cover body, and thereby using a cyclic heat input to set liquid temperatures inside the chamber to between 50 and 75 degrees Celsius in one cycle and to between 80 and 100 degrees Celsius in another cycle, and using a medium speed to a high speed.
